(19) United States
(12) Patent Application Publication
(10) Pub. No.: US 2015/0333667 A1
(43) Pub. Date: Nov. 19, 2015

(54) ELECTRIC MOTOR DRIVING DEVICE

(71) Applicant: Mitsubishi Electric Corporation, Tokyo (JP)

(72) Inventors: Masahiko FUJITA, Chiyoda-ku (JP); Yoshihiro TAKESHIMA, Chiyoda-ku (JP); Masaki YAMADA, Chiyoda-ku (JP)

(73) Assignee: Mitsubishi Electic Corporation, Tokyo (JP)

(21) Appl. No.: 14/513,318

(22) Filed: Oct. 14, 2014

(30) Foreign Application Priority Data
May 13, 2014 (JP) 2014-099222

(51) Int. Cl. H02P 6/00

(52) U.S. Cl. CPC H02P 6/002

(57) ABSTRACT

A decrease of inductance in a carrier frequency region being used is suppressed by connecting reactors capable of maintaining a fluctuation range of inductance within a predetermined range in the carrier frequency region in series to and between an inverter device converting electric power of an energy storage device and an electric motor. Consequently, the electric motor is controlled while an iron loss and an electromagnetic noise are reduced independently of characteristics of an iron material and a magnetic steel sheet material used as a core material of the electric motor.

### BACKGROUND OF THE INVENTION

1. Field of the Invention

The present invention relates to an electric motor driving device that supplies an electric motor with electric power from an energy storage device by controlling charging and discharging of the energy storage device or supplies the energy storage device with regenerative electric energy of the electric motor.

2. Description of the Related Art

A need for a gasoline car to improve fuel efficiency is increasing these days and attention is being paid to cars using electric energy as a technique achieving improvement of fuel efficiency. In particular, an eco-friendly car incorporating an energy storage device (lithium-ion battery, nickel-metal hydride battery, or the like), such as a hybrid car and a plug-in hybrid car, is becoming popular. Such a hybrid car combines an existing gasoline car and a system that obtains running motive power by converting a DC power supply supplied from the energy storage device to an AC power supply using an inverter and supplying the AC power supply to a running AC motor while the car is running, and conversely, stores electric energy due to regenerative braking applied to the AC motor into the energy storage device while the car is decelerating. Further, a plug-in hybrid can be fed with electric power from an outside.

In order to convert DC to AC in the inverter, an inverter adapted to PWM (Pulse Width Modulation) control is generally used. The PWM control is a method of driving a switching element with a PWM waveform generated by comparing a carrier with a command value.

Recently, a current in a constant-current waveform is obtained by using an insulated gate bipolar transistor (IGBT) or a metal-oxide semiconductor field-effect transistor (MOSFET) as a switching element for high-power use and by allowing the switching element to switch at a switching frequency set to several kHz to several tens kHz. However, because a current contains fine fluctuations or ripples, a current ripple occurs also in a current flowing to a motor or a generator. When this current ripple is large, an iron loss and an electromagnetic noise in the motor or the generator are increased and efficiency of the motor or the generator is deteriorated.

To overcome such an inconvenience, Patent Document 1 proposes to reduce an iron loss and an electromagnetic noise in the motor or the generator by reducing a current ripple (current pulsation) in a current supplied to the motor or the generator without unnecessarily increasing a switching loss in the inverter.

[Patent Document 1] JP-A-2009-291019 (FIGS. 1 and 2)

Patent Document 1 proposes to control a carrier frequency according to magnitude of a voltage command value inputted from an outside. Ina region where a voltage command value is large, the carrier frequency is set high whereas the carrier frequency is set low in a region where the voltage command value is small. An iron loss and an electromagnetic noise in the motor or the generator are reduced according to the content of the above setting. This proposal, however, fails to achieve a sufficient effect in practice.

A cause of this failure in fully reducing an iron loss and an electromagnetic noise is found in characteristics of an iron material and a magnetic steel sheet material used as a core material of the motor or the generator. More specifically, the proposal of Patent Document 1 is made for an operation on the assumption that inductance of a motor winding is constant. However, magnetic permeability of the iron material and the magnetic steel sheet material used as the core material of the motor or the generator has a frequency dependency, and this frequency dependent characteristic considerably affects the inductance. Although inductance takes a sufficient value in an extremely-low frequency region (several Hz to several hundred Hz), magnetic permeability decreases considerably in a given carrier frequency region (several kHz to several tens kHz) and so does the inductance. Consequently, there arises a problem that a current ripple becomes larger and hence an iron loss and an electromagnetic noise in the motor or the generator are increased.

### SUMMARY OF THE INVENTION

The invention was devised to solve the problems discussed above and has an object to provide an electric motor driving device that controls an electric motor, such as a motor and a generator, while reducing an iron loss and an electromagnetic noise by securing sufficient inductance in a carrier frequency region being used.

In the description below, a motor (electric motor) and a generator (electric generator) are collectively referred to as the electric motor. Also, the term, “electric motor driving device”, is used to represent an entire system including an electric motor as a driven subject, an energy storage device serving as a power supply, and a connection device between the energy storage device and the electric motor. Hence, the electric motor means a machine furnished with at least one of a power generation function and a motor function and the energy storage device means a machine furnished with at least one of a charging function and a discharging function.

An electric motor driving device according to one aspect of the invention includes an energy storage device, an electric motor, an inverter device that converts electric power exchanged between the energy storage device and the electric motor, and reactors capable of maintaining a fluctuation range of inductance within a predetermined range in a carrier frequency region. By connecting the reactors in series to and between the inverter device and the electric motor, a decrease of the inductance in a carrier frequency being used is suppressed.

The electric motor may be a three-phase AC electric motor and cores of the reactors connected to input terminals of respective phases of the three-phase AC electric motor may be coupled to one another.

The electric motor driving device configured as above can secure sufficient inductance in a carrier frequency region being used and hence a current ripple flowing to the electric motor can be reduced, which can in turn reduce an iron loss and an electromagnetic noise in the electric motor.

In addition, by coupling the cores of the reactors connected to the respective phases of the three-phase AC electric motor, the device can be reduced in size.

The foregoing and other objects, features, aspects, and advantages of the present invention will become more apparent from the following detailed description of the present invention when taken in conjunction with the accompanying drawings.

### BRIEF DESCRIPTION OF THE DRAWINGS

FIG. 1 is a view showing a configuration of an electric motor driving device according to a first embodiment of the invention;

FIG. 2 is a view schematically showing a relation of a frequency and inductance in respective components according to the first embodiment of the invention;

FIGS. 3A, 3B, and 3C are views schematically showing drive signals of respective IGBTs and currents flowing to windings of the electric motor according to the first embodiment of the invention;

FIG. 4 is a view showing a configuration of an electric motor driving device according to a second embodiment of the invention; and

FIG. 5 is a view showing a configuration of an electric motor driving device according to a third embodiment of the invention.

### DETAILED DESCRIPTION OF THE PREFERRED EMBODIMENTS

Hereinafter, an electric motor driving device of the invention will be described according to the drawings.

Same numeral references denote same or equivalent portions in the respective drawings.

### First Embodiment

Hereinafter, an electric motor driving device of the invention will be described according to the drawings.

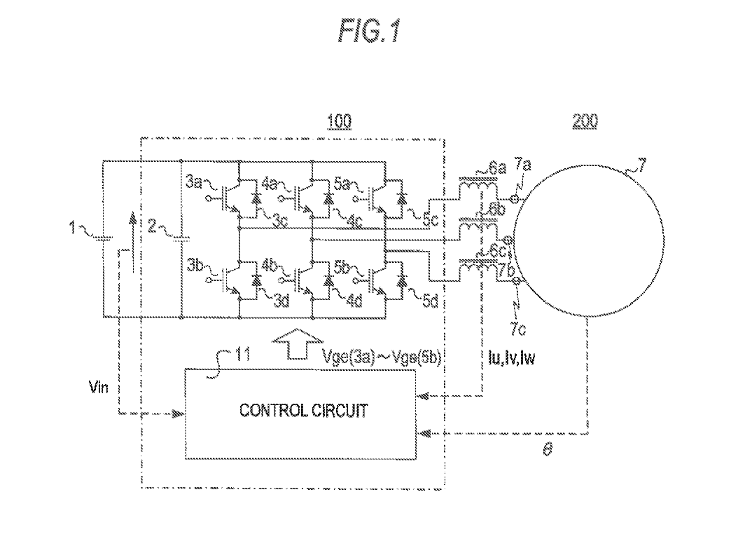

FIG. 1 is a view showing a configuration of an electric motor driving device according to a first embodiment of the invention. As is shown in the drawing, in an electric motor driving device 200, an energy storage device 1, an inverter device 100, and an electric motor 7 are connected in series, and reactors 6a, 6b, and 6c are connected between the electric motor 7 and the inverter device 100 in series, respectively, to AC terminals 7a, 7b, and 7c of respective phases of the electric motor 7.

The inverter device 100 is formed of a smoothing capacitor 2, an IGBT (Insulated Gate Bipolar Transistor) 3a through an IGBT 5b, a diode 3c through a diode 5d, and a control circuit 11. The electric motor driving device 200 includes the energy storage device 1, the inverter device 100, the reactors 6a through 6c, and the electric motor 7.

A lithium-ion battery, a nickel-metal hydride battery, or the like is used as the energy storage device 1. The energy storage device 1 is connected in parallel to the smoothing capacitor 2.

In the inverter device 100, an emitter terminal of the IGBT 3a and a collector terminal of the IGBT 3b are connected (hereinafter, this connection is referred to as the IGBT 3 arm), and this connection point and one end of the reactor 6a are connected. Likewise, an emitter terminal of the IGBT 4a and a collector terminal of the IGBT 4b are connected (hereinafter, this connection is referred to as the IGBT 4 arm), and this connection point and one end of the reactor 6b are connected. Also, an emitter terminal of the IGBT 5a and a collector terminal of the IGBT 5b are connected (hereinafter, this connection is referred to as the IGBT 5 arm), and this connection point and one end of the reactor 6c are connected.

Each of the IGBT 3 arm, the IGBT 4 arm, and the IGBT 5 arm is connected in parallel to the energy storage device 1.

The diodes 3c, 3d, 4c, 4d, 5c, and 5d are connected between the emitter terminals and the collector terminals of corresponding pairs of the IGBTs 3a through 5b, so that a current flows from the emitter terminal to the collector terminal. The reactors 6a, 6b, and 6c are connected, respectively, to the AC terminals 7a, 7b, and 7c of the respective phases of the electric motor 7. More specifically, the other end of the reactor 6a is connected to the AC terminal 7a, the other end of the reactor 6b is connected to the AC terminal 7b, and the other end of the reactor 6c is connected to the AC terminal 7c. Although it is not shown in the drawing, respective gate terminals of the IGBT 3a through the IGBT 5b are connected to corresponding drive terminals of the control circuit 11, so that a gate signal is supplied to each gate terminal.

Upon input of a voltage Vin of the energy storage device 1, the IGBT 3a and the IGBT 3b, the IGBT 4a and the IGBT 4b, and the IGBT 5a and the IGBT 5b repeat complementary ON and OFF actions under the control of the control circuit 11. Current phases of the IGBT 3 arm, the IGBT 4 arm, and the IGBT 5 arm are 120 degrees apart from one another. The control circuit 11 controls the driving of the IGBT 3a through the IGBT 5b by detecting a rotational angle θ of the electric motor 7, respective winding currents Iu, Iv, and Iw, and a smoothing capacitor voltage and generating ON and OFF drive signals Vge(3a), Vge(3b), Vge(4a), Vge(4b), Vge(5a), and Vge(5b) of the IGBTs 3a through 5b according to information on the detection result.

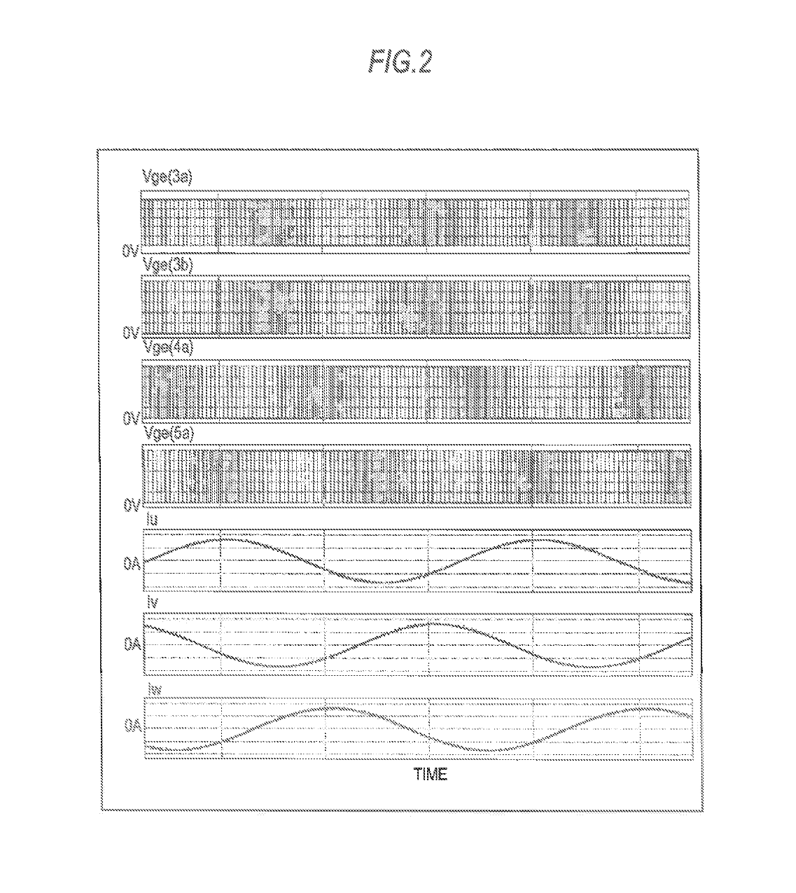

FIG. 2 schematically shows a part of the ON and OFF drive signals to the IGBT 3a, the IGBT 3b, the IGBT 4a, the IGBT 4b, the IGBT 5a, and the IGBT 5b in the inverter device 100 of FIG. 1, that is, the ON and OFF drive signals Vge(3a), Vge (3b), Vge(4a), and Vge(5a), and output signals Iu, Iv, and Iw of the inverter device 100.

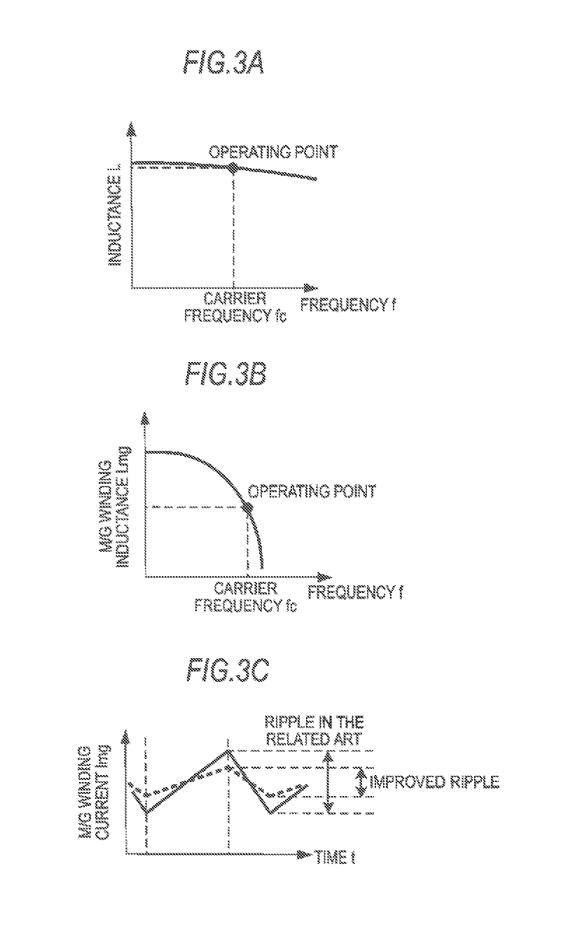

A generation mechanism of a current ripple will now be described using FIGS. 3A through 3C.

FIG. 3A shows a relation of a frequency and inductance at the reactor 6a, the reactor 6b, and the reactor 6c of FIG. 1. This relation indicates that inductance fluctuates little whether a carrier frequency is raised or lowered. It is particularly necessary to select and use a reactor capable of maintaining a fluctuation range of the inductance within a predetermined range in the carrier frequency region as shown in FIG. 3A. FIG. 3B shows a relation of a carrier frequency of the electric motor 7 and inductance. This relation indicates a situation in which inductance decreases significantly depending on frequency regions byway of example.

When a voltage difference between the inverter voltage Vinv applied to one end of the winding of the electric motor 7 from an output of the inverter device 100 and an inductive voltage Vmot induced proportionately to a rotational speed at the other end of the winding of the electric motor 7 is applied to synthetic inductance of inductance of the reactor 6a (reactor 6b or reactor 6c) and winding inductance of the electric motor 7, a current increases monotonically. At the following timing, the current decreases monotonically as energy stored in the synthetic inductance is released. This is a mechanism by which a current ripple is generated.

Consequently, as is shown in FIG. 3C, because the winding inductance of the electric motor 7 caused by amplitude of the current ripple decreases significantly in the carrier frequency region of the inverter, the current ripple is increased in the related art. On the contrary, in the first embodiment of the invention, the reactors 6a through 6c capable of maintaining the inductance even in the carrier frequency region are added in series to the electric motor 7. Hence, the synthetic inductance in the carrier frequency region caused by the amplitude of the current ripple can be increased, which can in turn reduce the current ripple.

It thus becomes possible to reduce an iron loss and an electromagnetic noise of the electric motor.

The first embodiment of the invention has described a case where the insulated gate bipolar transistors (IGBTs) are used as the switching elements. It should be appreciated, however, that similar effects can be obtained when bipolar transistors, metal-oxide semiconductor field-effect transistors (MOSFETs), transistors, or silicon carbide MOSFETs are used as the switching elements.

### Second Embodiment

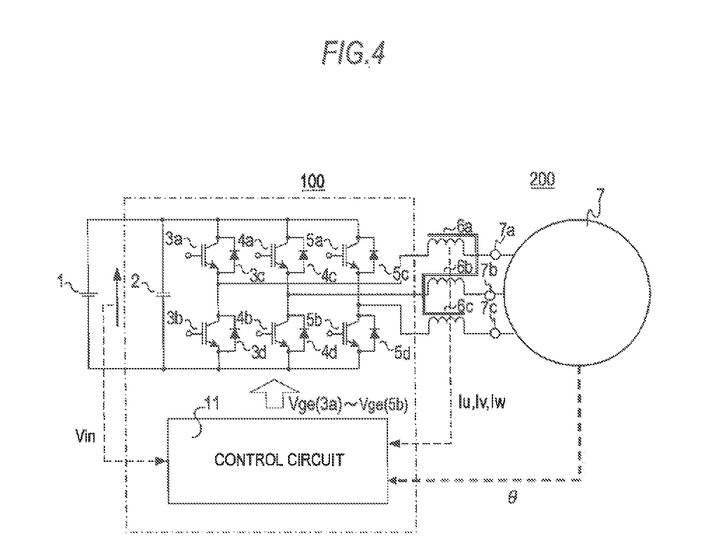

Hereinafter, an electric motor driving device according to a second embodiment of the invention will be described using FIG. 4.

A circuit configuration of the electric motor driving device according to the second embodiment of the invention is basically the same as the one described in the first embodiment above and a description of the same portions is not repeated herein. A difference is that cores of reactors 6a through 6c capable of maintaining inductance even in a carrier frequency region are coupled to one another. The number of reactors can be reduced as a result.

A circuit operation of the electric motor driving device 200 according to the second embodiment of the invention is the same as the one described in the first embodiment above.

In addition to the effects of the electric motor driving device of the first embodiment above, the electric motor driving device according to the second embodiment of the invention can satisfy a need of a size reduction.

The second embodiment of the invention has described a case where the insulated gate bipolar transistors (IGBTs) are used as the switching elements. It should be appreciated, however, that similar effects can be obtained when bipolar transistors, metal-oxide semiconductor field-effect transistors (MOSFETs), silicon carbide transistors, or silicon carbide MOSFETs are used as the switching elements.

### Third Embodiment

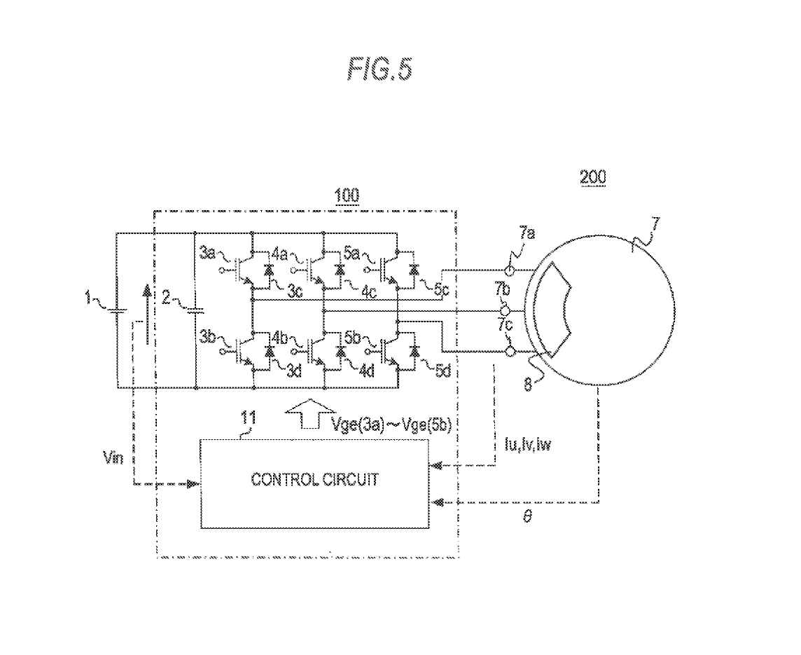

Hereinafter, an electric motor driving device 200 according to a third embodiment of the invention will be described using FIG. 5.

A circuit configuration of the electric motor driving device according to the third embodiment of the invention is basically the same as the one described in the first embodiment above and a description of the same portions is not repeated herein. A difference is that a reactor core 8 with a characteristic to maintain inductance even in a carrier frequency region is used as a core material of an electric motor 7. Accordingly, the reactor 6a through the reactor 6c can be replaced by the reactor core 8 and a need of a further size reduction can be satisfied.

A circuit operation of the electric motor driving device 200 according to the third embodiment of the invention is the same as the one described in the first embodiment above.

The electric motor driving device 200 according to the third embodiment of the invention can obtain effects same as those of the electric motor driving device 200 of the first embodiment above.

The third embodiment of the invention has described a case where the insulated gate bipolar transistors (IGBTs) are used as the switching elements. It should be appreciated, however, that similar effects can be obtained when bipolar transistors, metal-oxide semiconductor field-effect transistors (MOSFETs), silicon carbide transistors, or silicon carbide MOSFETs are used as the switching elements.

It should be appreciated that the respective embodiments of the invention can be combined without any restriction and the respective embodiments can be modified or omitted as needed within the scope and sprit of the invention.

Various modifications and alterations of this invention will be apparent to those skilled in the art without departing from the scope and spirit of this invention, and it should be understood that this is not limited to the illustrative embodiments set forth herein.

What is claimed is:

1. An electric motor driving device, comprising:
an energy storage device;
an electric motor;
an inverter device that converts electric power exchanged between the energy storage device and the electric motor; and
reactors capable of maintaining a fluctuation range of inductance within a predetermined range in a carrier frequency region,
wherein the reactors are connected in series to and between the inverter device and the electric motor.

2. The electric motor driving device according to claim 1, wherein:
the electric motor is a three-phase AC electric motor; and
cores of the reactors connected to input terminals of respective phases of the three-phase AC electric motor are coupled to one another.

3. The electric motor driving device according to claim 1, wherein:
a reactor core with a characteristic to maintain inductance even in the carrier frequency region is used as a core material of the electric motor; and
the reactors connected in series to and between the inverter device and the electric motor are replaced by the reactor core.
